(19) United States
(12) Patent Application Publication
(10) Pub. No.: US 2008/0145140 A1
(43) Pub. Date: Jun. 19, 2008

(54) Front tube telescopic assembly of bicycle

(76) Inventor: Chao-Hu Chen, Taichung (TW)

Correspondence Address: CHAO-HU CHEN, 235 Chung - Ho, Box 8-24, Taipei, omitted

(21) Appl. No.: 11/637,753

(22) Filed: Dec. 13, 2006

(51) Int. Cl. B62K 19/18

(52) U.S. Cl. 403/24

(57) ABSTRACT

A front tube telescopic assembly of a bicycle comprises a locking unit having a notch at one side thereof; a lower end of the locking unit having an outer threaded portion for screwing a tightening unit so as to tighten the locking unit. The locking unit is screwed to an upper end of a front tube by using a screwing unit. An upper end of the locking unit is enclosed by a C sleeve. A telescopic tube is received in a hole of the front tube; and one side of the telescopic tube has a long trench. A screwing unit passes through the long trench, the C sleeve and the locking unit to telescopically retain the telescopic tube in the front tube.

### FIELD OF THE INVENTION

The present invention relates to bicycles, and particularly to a front tube telescopic assembly of a bicycle, which has a C sleeve and a tightening unit which enclose a locking unit and the locking unit encloses a front tube which receives a telescopic tube so that the front tube telescopic assembly is firmly secured.

### BACKGROUND OF THE INVENTION

In the prior art bicycle front tube, a buckling ring encloses the front tube. The ring has inner threads and a driving sleeve which is installed at an upper side of the ring. The sleeve is formed with a round threaded portion. A periphery of the threaded portion has outer threads for engaging with the inner threads of the sleeve so as to enforce the ring to enclose the front tube. Thus in the prior art, the tightening function is achieved by the ring and the threaded portion. However, the prior art structure has only one tightening assembly. After using for a long time, the ring and the thread portion will become loose so that the front tube displaces and shifts from a correct position. Thus some dangerous accidents will occur.

### SUMMARY OF THE INVENTION

Accordingly, the primary object of the present invention is to provide a front tube telescopic assembly of a bicycle, which has a C sleeve and a tightening unit which enclose a locking unit and the locking unit then encloses a front tube which receives a telescopic tube so that the front tube telescopic assembly is firmly secured.

To achieve above objects, the present invention provides a front tube telescopic assembly of a bicycle which comprises a locking unit having a notch at one side thereof; a lower end of the locking unit having an outer threaded portion for screwing a tightening unit for tightening the locking unit. The locking unit is screwed to an upper end of an front tube by using a screwing unit. An upper end of the locking unit is enclosed by a C sleeve. A telescopic tube is received in a hole of the front tube; and one side of the telescopic tube has a long trench. A screwing unit passes through the long trench, the C sleeve and the locking unit to telescopically retain the telescopic tube in the front tube.

The various objects and advantages of the present invention will be more readily understood from the following detailed description when read in conjunction with the appended drawing.

### BRIEF DESCRIPTION OF THE DRAWINGS

FIG. 1 is an exploded schematic view of the front tube telescopic assembly of a bicycle of the present invention.

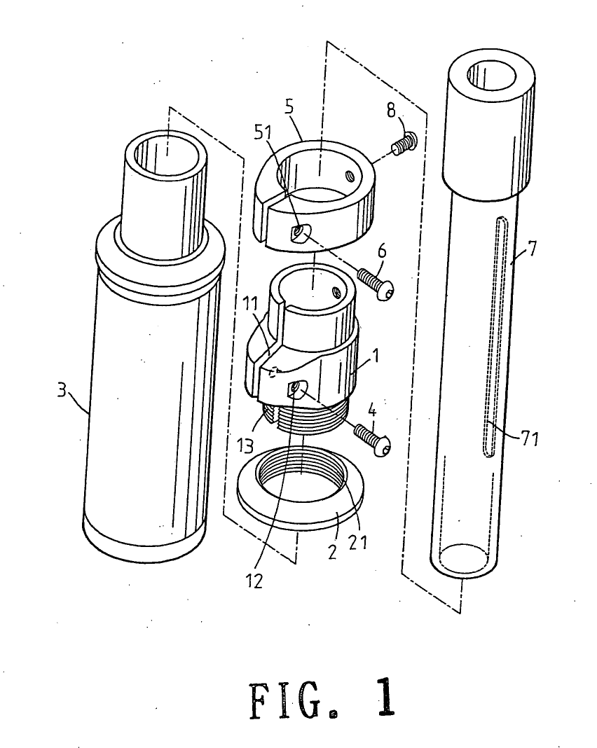

FIG. 2 is a schematic view of the assembly of the front tube telescopic assembly of a bicycle of the present invention.

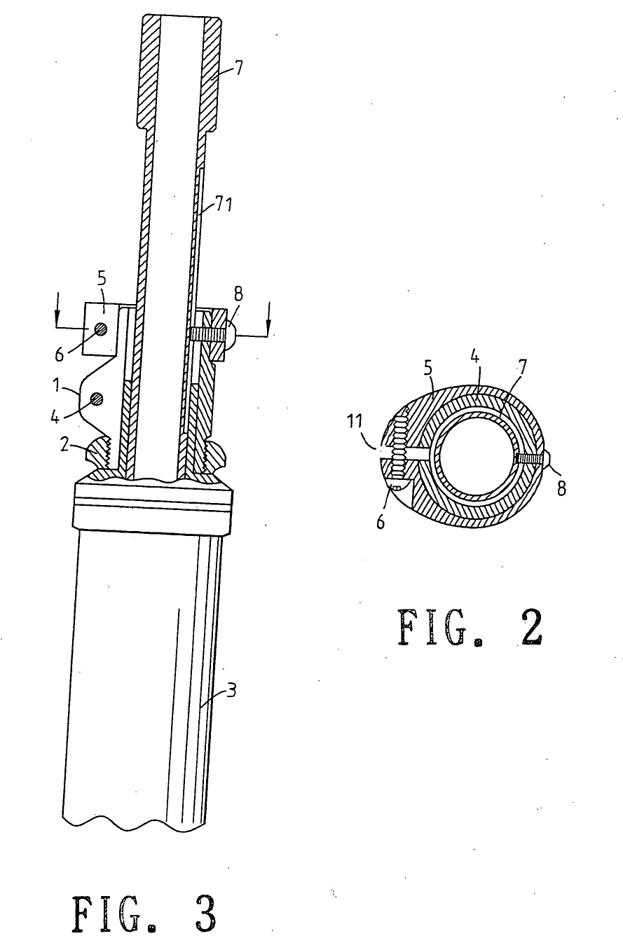

FIG. 3 is a lateral schematic view about the front tube telescopic assembly of a bicycle of the present invention.

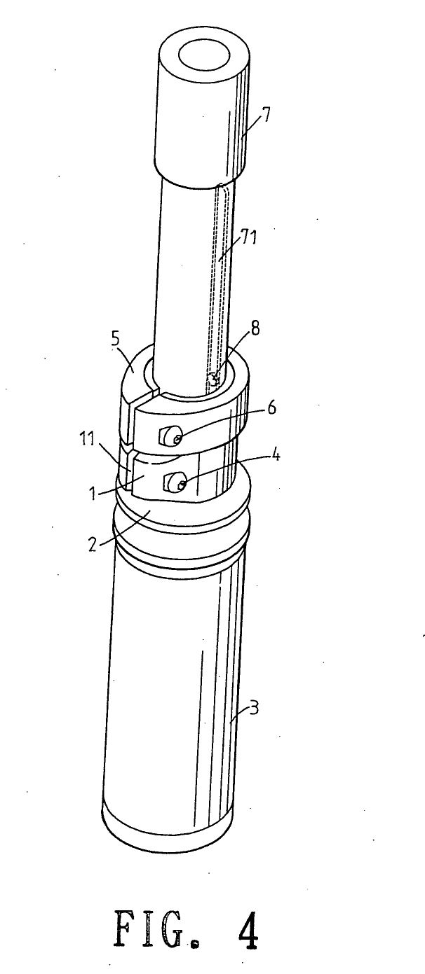

FIGS. 4 and 5 are assembled schematic views of the front tube telescopic assembly of a bicycle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A front tube telescopic assembly of a bicycle comprises the following elements.

A locking unit 1 has a notch 11 at one side thereof. The notch 11 has a threaded hole 12 which is matched with a screwing unit 4. A lower end of the locking unit 1 has an outer threaded portion 13.

A tightening unit 2 has an O shape. An interior of the tightening unit 2 is formed with an inner threaded portion 21 which can be screwed to the outer threaded portion 13 of the locking unit 1.

A C sleeve 5 is at an upper end of the locking unit 1. The C sleeve 5 has a threaded hole 51. In assembly, the C sleeve 5 encloses an upper end of the locking unit 1 and a screwing unit 6 passes through the threaded hole 51 so as to tighten the C sleeve 5 upon the locking unit 1.

A front tube 3 has an inner hole for receiving a telescopic tube 7. In assembly, the tightening unit 2 encloses a lower end of the locking unit 1 and the C sleeve 5 encloses the upper end of the locking unit 1. Then the locking unit 1 encloses an upper end of the front tube 3. One side of the telescopic tube 7 is formed with a long trench 71. A screwing unit 8 passes through the long trench 71, the C sleeve 5 and the locking unit 1 so that the telescopic tube 7 can telescopically move.

In assembly, the tightening unit 2 encloses a lower end of the locking unit 1 and the C sleeve 5 encloses the upper end of the locking unit 1. Then the locking unit 1 encloses an upper end of the front tube 3. Then the telescopic tube 7 is telescopically received in the hole in the front tube 3. When the tightening unit 2 tightly encloses the locking unit 1, the space of the notch 11 will reduce so that the locking unit 1 tightly encloses the front tube 3. Furthermore the C sleeve 5 enclosing the upper end of the locking unit 1 will further encloses the locking unit 1. Thus, by the tightening effect of the C sleeve 5, locking unit 1 and the tightening unit 2, and the locking of the screwing unit 8, the telescopic tube 7 can be fixed firmly after adjustment.

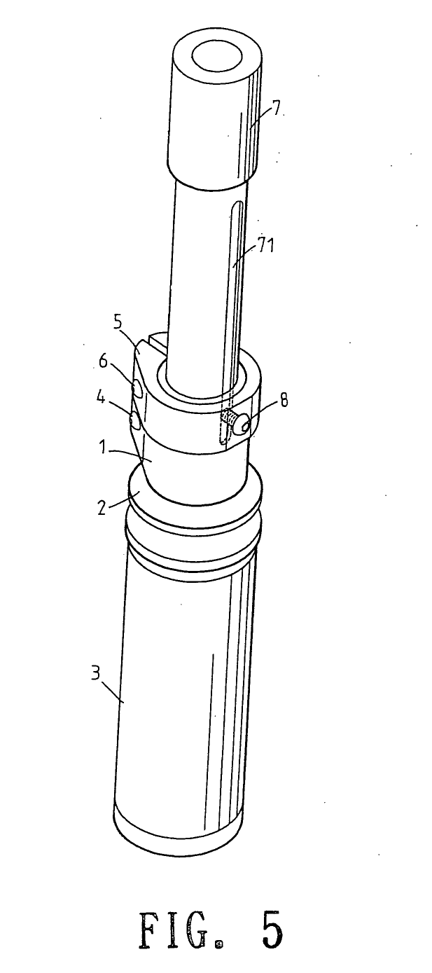

Referring to FIGS. 4 and 5, after assembly of the present invention, if it is desired to adjust the telescopic tube 7, the tightening unit 2 at the lower end of the locking unit 1 can be released and then the screwing unit 4 on the locking unit 1 is unlocked. Then the screwing unit 6 for fixing the C sleeve 5 upon the locking unit 1 is released. Then the screwing unit 8 is loosed. Thus, the telescopic tube 7 can be adjusted longitudinally. When the telescopic tube 7 is adjusted to a predetermined position, the screwing unit 8 is tightened so that the telescopic tube 7 is positioned. Then the screwing unit 6 is tightened to fix the C sleeve 5 to the locking unit 1. Finally, the tightening unit 2 is screwed to the outer threaded portion 13 of the locking unit 1. Thus the front tube 3 is tightly engaged with the telescopic tube 7.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A front tube telescopic assembly of a bicycle comprising:
a locking unit having a notch at one side thereof; a lower end of the locking unit having an outer threaded portion for screwing a tightening unit and thus to tighten the locking unit.

2. The front tube telescopic assembly of a bicycle as claimed in claim 1, wherein the locking unit is screwed to an upper end of a front tube by using a screwing unit.

3. The front tube telescopic assembly of a bicycle as claimed in claim 1, wherein an upper end of the locking unit is enclosed by a C sleeve.

4. The front tube telescopic assembly of a bicycle as claimed in claim 2, wherein a telescopic tube is received in a hole of the front tube; and one side of the telescopic tube has a long trench.

5. The front tube telescopic assembly of a bicycle as claimed in claim 1, wherein a screwing unit passes through the long trench, the C sleeve and the locking unit to telescopically retain the telescopic tube in the front tube.
